(19) United States
(12) Patent Application Publication
(10) Pub. No.: US 2007/0178787 A1
(43) Pub. Date: Aug. 2, 2007

(54) One swipe anti-bacteria disposable toilet seat wipe

(76) Inventors: Colbert Johnson, Richton Park, IL (US); Valma Johnson, Richton Park, IL (US)

Correspondence Address: Hiram Peacock, 12655 S. Cowe Ave, Chicago, IL, 60628, US

(21) Appl. No.: 11/699,623

(22) Filed: Jan. 30, 2007

Related U.S. Application Data
(60) Provisional application No. 60/763,057, filed on Jan. 30, 2006.

(51) Int. Cl. B32B 27/04; B32B 5/02

(52) U.S. Cl. 442/123; 442/59

(57) ABSTRACT

An improved anti-bacteria wipe for cleansing and drying toilet seats in public restrooms that is biodegradable and destroys germs and bacteria on contact. The wipe is comprised of three layers. The pre-moistened first layer is infused with a quick drying anti-bacteria solution that kills germs and bacteria on contact. The second layer is an ultra thin biodegradable plastic to prevent seepage between the first and third layers. The third layer is a dry absorbent material used to remove any remaining moisture from the toilet seat. The wipe is sealed in an outer pouch to maximize shelf life. The wipe can easily and safely be flushed down the toilet following use.

### RELATED TO U.S. APPLICATION DATA

This application is entitled to the benefit of Provisional Patent Application Ser. No. 60/763,057 filed on Jan. 30, 2006 by the present inventors.

### FIELD OF THE INVENTION

The present invention relates generally to a means for cleaning a toilet seat prior to use. More specifically, the invention provides an improved toilet seat wipe for cleaning and drying a toilet seat prior to use.

### BACKGROUND OF THE INVENTION

As unpleasant as it may seem, public toilets are rife with germs and bacteria. According to a report filed by the American Medical Association (AMA), touching a toilet seat just once can leave enough germs and bacteria on the skin, that hands must be washed at least five to six times consecutively, just to get rid of the majority of these harmful agents. Easily thriving on hands, these germs and bacteria are also easily deposited onto the legs and buttocks. Realistically, few people, if anyone, would have time or even consider showering five or six times after using the restroom. Most public toilets are a breeding ground for microscopic fecal coli form, a potentially deadly form of the E. Coli virus. In fact, the AMA also reports that as many as 25 percent of people leave the restroom with traces of fecal coliform (usually E. Coli) on their bodies. Furthermore, it has been found that the common cold and influenza are easily transmitted from one person to the next, via the public toilet. While anyone can be exposed to illness from contact with a contaminated toilet seat, elderly persons, those suffering with immune deficiency diseases, chemotherapy patients, pregnant women, young children, and people with diabetes are particularly susceptible to these germs and bacteria.

Clearly no matter how well a rest room appears to be maintained, it can nonetheless be a breeding ground for infectious matter. For the millions of those who must share toilet facilities at work, and for the countless others who must use the restroom when shopping, dining out, going to a movie, or in any other public place, using a public toilet can be an unsettling prospect. Perhaps this is why so many people improvise; covering the toilet seat with paper towels, tissue or toilet paper; all in attempts to avoid contact with the germs and bacteria that are left behind by other people. An awkward solution at best, covering the toilet seat in this manner most often leads to clogged plumbing and excessive amounts of waste paper on the restroom floor.

As a solution to this problem, many public restrooms have begun providing ultra-thin disposable toilet seat covers inside toilet stalls to help users with their apprehension of coming into direct contact with the toilet seat. These seat covers are typically made of a paper material and are in no way preventive of the spread of microorganisms, especially if they come into contact with liquids whether splashed or sprayed from within or around the toilet. The seat covers also do not address the issue of destroying bacteria and microorganisms that are present on the toilet seat.

Most anti-bacteria wipes act as a disinfectant which consists of an agent that does not ordinarily have the necessary ingredients to remove most or all of the microorganisms that may be found on a soiled toilet seat.

Various pre-moistened disposable toilet seat cleaning products are known in the art. Typical of such wipes and wiping devices are the ones shown in U.S. Pat. Nos. 5,025,524; 4,601,081; 4,575,891; and 4,998,984, all using various methods for cleaning a toilet seat. There remains a need for an improved wipe capable of destroying bacteria and drying a public toilet seat to allow a user to use a public restroom without apprehension.

### OBJECTS AND ADVANTAGES

The object of the present invention is to overcome the aforementioned disadvantages of prior art wipes and provide an anti-bacteria wipe that is affordable, easily portable, and easy to manufacture.

It is a further object of the invention to provide a wipe that effectively eliminates the spread of germs and bacteria between users.

It is a further object of this invention to provide a wipe that is biodegradable, and can be easily disposed of without clogging or damaging the waste disposal system.

It is a further object of this invention to provide a wipe that would greatly reduce the threat of communicable diseases, such as the common cold, flu, or in more serious instances, the E. Coli virus, from infiltrating the body's immune system.

### SUMMARY OF THE INVENTION

The One Swipe Anti-bacteria Disposable Toilet Seat Wipe is specifically designed to act as a cleansing and drying device to remove any moisture from the toilet seat prior to use.

The One Swipe Anti-bacteria Disposable Toilet Seat Wipe is a two sided wipe comprised of three layers of biodegradable materials, where the middle layer is a biodegradable plastic to keep the pre-moistened anti-bacteria solution in the absorbent first layer separate from the absorbent drying pad of the third layer. The anti-bacteria solution infused into the first layer is comprised of a solution capable of neutralizing endospores and pathogens, E. Coli and influenza, bodily fluids including blood, or even HIV and the AIDS virus.

### BRIEF DESCRIPTION OF THE DRAWINGS

This invention, together with other objects, features, aspects and advantages thereof, will be more closely understood from the following descriptions, considered in conjunction with the accompanying drawings.

FIG. 1 is an exploded view of the One Swipe Anti-bacteria Disposable Toilet Seat Wipe.

FIG. 2 is a side view of the One Swipe Anti-bacteria Disposable Toilet Seat Wipe.

FIG. 3 is a perspective top view of the sealed storage pouch that contains the One Swipe Anti-bacteria Disposable Toilet Seat Wipe

### DETAILED DESCRIPTION

The present invention provides a practical solution to the aforementioned challenges. The One Swipe Anti-bacteria Disposable Toilet Seat Wipe is a bio-degradable wipe, designed specifically to be effortlessly glided across the surface of a toilet seat, killing germs and bacteria on contact.

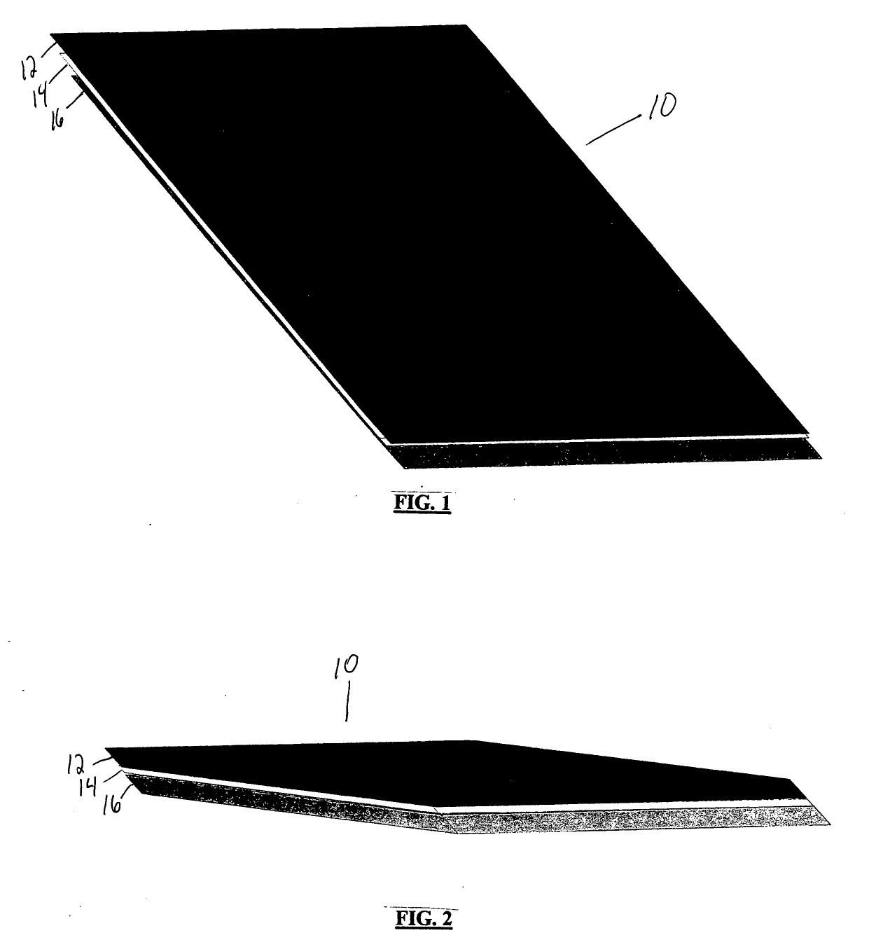

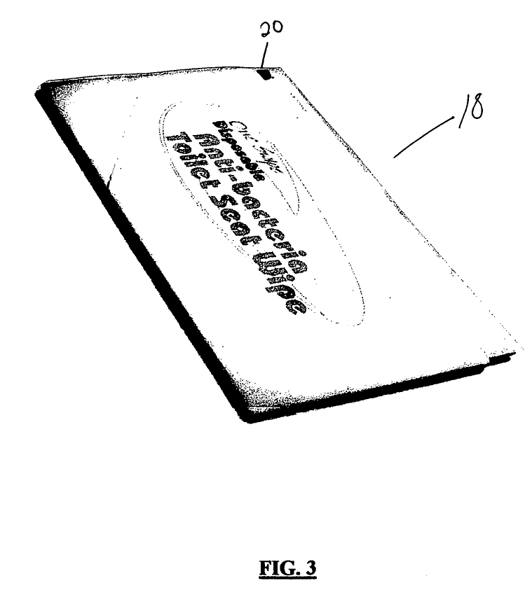

FIGS. 1 and 2 illustrate that the One Swipe Anti-bacteria Disposable Toilet Seat Wipe 10 is constructed of three layers of biodegradable and disposable sanitary material and is individually wrapped in a sealed plastic pouch 18. The first layer 12 of each One Swipe Anti-bacteria Disposable Toilet Seat Wipe is infused with a hypoallergenic anti-bacteria solution, formulated to kill germs and bacteria on contact. The first layer 12 can be composed of any suitable material including synthetic fibers, natural fibers, and unwoven biodegradable material or paper such as wet strength tissue or dry laid paper. The third layer 16 of the wipe 10 is a dry absorbent pad for use in drying the toilet seat after the solution has been applied. The first 12 and third 16 layers are separated by a second layer 14 comprised of an ultra thin biodegradable plastic. The ultra thin plastic second layer 14 prevents the solution from seeping through from the first layer 12 to the dry third layer 16. The One Swipe Anti-bacteria Disposable Toilet Seat Wipe 10 can be produced in fragranced, fragrance free, as well as with alcohol or alcohol free varieties. As seen in FIG. 3, an individually sealed plastic pouch 18 holds the One Swipe Anti-bacteria Disposable Toilet Seat Wipe 10, which can be easily accessed from this pouch by way of a handy pull tab 20, which runs along the upper length of the pouch 18. The front of the pouch 18 carries the One Swipe Anti-bacteria Disposable Toilet Seat Wipe logo, while instructions for use are imprinted on the back of the pouch. The One Swipe Anti-bacteria Disposable Toilet Seat Wipes 10 could also be sold in multi-package containers, ideal for household use. Alternately, the One Swipe Anti-bacteria Disposable Toilet Seat Wipe 10 could be dispensed in vending machines such as those found in restrooms in public establishments.

Use of the One Swipe Anti-bacteria Disposable Toilet Seat Wipe is very simple and straight forward. First, opening the One Swipe Anti-bacteria Disposable Toilet Seat Wipe pouch 18 via the pull tab 20, the user would remove the wipe 10 from the storage pouch 18. The user would then simply swipe the pre-moistened side of the One Swipe Anti-bacteria Disposable Toilet Seat Wipe 10 across the surface of a toilet seat, enabling the anti-bacteria solution to kill germs and bacteria on contact. To ensure maximum dryness of the toilet seat before use, the user can turn the wipe 10 over so that the dry side faces down, and dry the surface of the toilet seat with the dry third layer 16 of the wipe 10. After drying the seat, the user would drop the soiled, biodegradable wipe 10 directly into the toilet bowl, and then use the freshly cleansed facilities.

### PREFERRED EMBODIMENT

In a preferred embodiment the One Swipe Anti-bacteria Disposable Toilet Seat Wipe is approximately 3″×3″ square. The non-woven fiber of the first layer is absorbent yet capable of releasing the quick drying anti-bacteria solution upon contact with the toilet seat. The plastic second layer prevents seepage of the solution onto the dry third layer of absorbent pad that is used to complete the drying of the toilet seat.

### CONCLUSION, RAMIFICATIONS, AND SCOPE

Accordingly, the reader will see that the One Swipe Anti-bacteria Disposable Toilet Seat Wipe provides an effective portable and environmentally friendly wipe for users of public restroom facilities. Some of the additional advantages of the One Swipe Anti-bacteria

Disposable Toilet Seat Wipe are that:
1. It offers a simple and effective means of preventing the spread of communicable diseases;
2. It is extremely portable and can be used to cleanse other public facilities including public telephones, restroom door handles, and a variety of other breeding grounds;
3. Its small size and biodegradability prevent undue strain on the waste disposal system.

Although the description above contains much specificity, it should not be construed as limiting the scope of the invention, but as merely providing illustrations of some of the presently preferred embodiments of this invention. For example, other types of anti-bacteria agents can replace the existing ones; and additional restorative and natural emollients could be added. Additionally the wipe can be manufactured in a wide variety of sizes including wipes as small as 2″×1″ or approximately 3″×7″, which is large enough to cover the entire hand of a user. Thus the scope of the invention should be determined by the appended claims and their legal equivalents, rather than by the examples given.

What is claimed is:

1. A one swipe anti-bacteria disposable toilet seat wipe comprising:
an absorbent first layer infused with an anti-bacteria solution;
a second layer, being substantially impervious to the solution of said first layer and having a top side and a bottom side, where the top side is attached to said first layer;
a substantially dry and absorbent third layer that is attached to the bottom side of said second layer.

2. The one swipe anti-bacteria disposable toilet seat wipe of claim 1 wherein said solution infused in the first layer is capable of cleansing the toilet seat on contact.

3. The one swipe anti-bacteria disposable toilet seat wipe of claim 2 wherein the wipe is substantially biodegradable as to be easily disposed of by flushing down the toilet.

4. The one swipe anti-bacteria disposable toilet seat wipe of claim 3 further comprising a sealable plastic pouch to enclose the wipe;
said sealable pouch having a pull tab to break the seal on the pouch.

5. The one swipe anti-bacteria disposable toilet seat wipe of claim 4 wherein said solution further comprises an aqueous alcoholic composition to speed drying.

6. The one swipe anti-bacteria disposable toilet seat wipe of claim 4 wherein said solution is selected from the group consisting of: a germicide, a sterilizer, an aqueous alcoholic composition, an emollient, a fragrance, and combinations thereof.

7. The one swipe anti-bacteria disposable toilet seat wipe of claim 4 wherein said solution is selected from the group consisting of: a phenol compound, aloe vera, an aqueous alcoholic composition, hydro-peroxide, leptospermum scoparium, kunzea ericoides, and combinations thereof.

8. The one swipe anti-bacteria disposable toilet seat wipe of claim 2 wherein said solution is selected from the group consisting of: purified or distilled water, liquid soap, zinc pyrithione, black walnut green hull extract, olive leaf, aloe vera, leptospermum scoparium, kunzea ericoides, and combinations thereof.

9. A wiping device for cleansing toilet seats on contact comprising:
a first layer having a top side and a bottom side;
said first layer including an infusion of a liquid anti-bacteria means formulated to kill germs and bacteria on contact;
said first layer being composed of a biodegradable sanitary paper;
a second layer having a top side and a bottom side;
said top side of the second layer being attached to the bottom side of said first layer;
said second layer being composed of an ultra thin biodegradable plastic to prevent moisture seepage between the layers;
a third layer having a top side and a bottom side;
said third layer being comprised of a substantially dry absorbent biodegradable material;
said top side of the third layer being attached to the bottom side of the second layer.

10. The wiping device of claim 9 further comprising a sealable plastic pouch to enclose the wipe;
said sealable pouch having a pull tab to break the seal on the pouch.

11. The wiping device of claim 10 wherein said sealable plastic pouch is biodegradable.
